(19) United States
(12) Patent Application Publication
(10) Pub. No.: US 2014/0038072 A1
(43) Pub. Date: Feb. 6, 2014

(54) DEVICE AND METHOD FOR DETECTING COOLANT LEVEL IN THERMAL MANAGEMENT SYSTEM FOR FUEL CELL VEHICLE

(71) Applicants: Kia Motors Corporation, Seoul (KR); Hyundai Motor Company, Seoul (KR)

(72) Inventors: Su Dong Han, Yongin (KR); Gi Young Nam, Suwon (KR)

(73) Assignees: Kia Motors Corporation, Seoul (KR); Hyundai Motor Company, Seoul (KR)

(21) Appl. No.: 14/054,354

(22) Filed: Oct. 15, 2013

Related U.S. Application Data
(62) Division of application No. 13/600,762, filed on Aug. 31, 2012.

(30) Foreign Application Priority Data
May 7, 2012 (KR) 10-2012-0048192

(51) Int. Cl. H01M 8/04

(52) U.S. Cl. CPC H01M 8/04417; H01M 8/04925
USPC 429/428

(57) ABSTRACT

Disclosed are a device and method for detecting the coolant level in a thermal management system for a fuel cell vehicle, which can accurately and rapidly detect the lack of coolant using a detection value of a pressure sensor. That is, the present invention provides a device and method for detecting the coolant level in a thermal management system for a fuel cell vehicle, which can accurately and rapidly monitor the lack of coolant by calculating in real time the lack of coolant based on a change in slope value and a change in amplitude of a detection value of a pressure sensor according to the flow of coolant while the pressure sensor is mounted in a coolant line connected to an inlet of a fuel cell stack and a reservoir is connected to a pressure cap of a radiator.

### CROSS-REFERENCE TO RELATED APPLICATION

This application claims under 35 U.S.C. §119(a) the benefit of Korean Patent Application No. 10-2012-0048192 filed May 7, 2012, the entire contents of which are incorporated herein by reference.

### BACKGROUND

(a) Technical Field

The present invention relates to a device and method for detecting the coolant level in a thermal management system for a fuel cell vehicle. More particularly, it relates to a device and method for detecting the coolant level in a thermal management system for a fuel cell vehicle, which can accurately and rapidly detect the lack of coolant using a detection value of a pressure sensor.

(b) Background

A typical fuel cell system mounted in a fuel cell vehicle includes a fuel cell stack for generating electricity via an electrochemical reaction, a hydrogen supply system configured to supply hydrogen as a fuel to the fuel cell stack, an oxygen (air) supply system configured to supply oxygen-containing air as an oxidant required for the electrochemical reaction in the fuel cell stack, a thermal management system (TMS) configured to remove reaction heat from the fuel cell stack to the outside of the fuel cell system, control an operation temperature of the fuel cell stack, and performing water management functions, and a system controller configured to control overall operation of the fuel cell system.

FIG. 4 shows a coolant circulation loop in the thermal management system which controls the operation temperature of the fuel cell stack. As shown in FIG. 4, the thermal management system essentially includes a pump 11 for circulating coolant to a fuel cell stack 10 and a radiator 12 configured to cool the coolant discharged from the fuel cell stack 10, and further includes an ion filter 16 for filtering ions extracted from a cooling loop.

Moreover, a three-way valve 13 and a COD 14 are arranged in parallel to each other on a line extending from an outlet of the radiator 12 to the fuel cell stack 10, and a coolant supplement line extending from a reservoir 15 is connected to a line extending from a coolant outlet of the fuel cell stack 10 to the pump 11. Here, the coolant circulation loop is divided into a cooling loop and a heating loop according to the temperature of the fuel cell stack and includes a filter loop for removing ions from the coolant.

The cooling loop is formed when the three-way valve 13 is opened so that the coolant discharged from the radiator 12 flows to the fuel cell stack 10. That is, the cooling loop is provided so that the low temperature coolant cooled by the radiator 12 can be supplied to the fuel cell stack 10. The heating loop is formed when the three-way valve 13 is opened so that the coolant discharged from the outlet of the radiator 12 is cut off and the coolant from the pump 11 is supplied. Moreover, the filter loop is configured so that the coolant flows from the rear line of the pump 11 to the ion filter 16 and then the coolant from which ions are removed flows to the front line of the pump 11. In the thermal management system, a normal pressure cap 17 is mounted at the top of the radiator 12, and the reservoir 15 has an open air top structure and is provided with a coolant level sensor 18 mounted therein.

When coolant is lost in the cooling loop and the heating loop of the coolant circulation loop, a negative pressure is generated on the inlet side of the pump so that the coolant in the reservoir is rapidly supplied to the front line of the pump through the coolant supplement line, thus supplementing the lost coolant. However, when the coolant in the reservoir is rapidly discharged, the coolant level sensor for detecting the coolant level may malfunction due to the generation of a large amount of air bubbles and due to the repeated circulation of the coolant like water sloshing, which is problematic.

Moreover, when coolant is lost in the cooling loop and the heating loop, the coolant level sensor mounted in the reservoir can accurately detect the coolant level only when the coolant level of the reservoir is lowered as the temperature of the coolant decreases once the vehicle is off or idling. As a result, it is often impossible to accurately and rapidly detect the coolant level at the same time as when the coolant is lost.

Furthermore, in order to mount the coolant level sensor for detecting the coolant level in the reservoir, a packaging space of 25×15×40 mm is required, which may make it difficult to mount the coolant level sensor when the packaging space is insufficient. Even when the water level sensor is mounted either on the coolant loop or on the heating loop in terms of the utilization of the packaging space, when the coolant mixed with water and air is circulated (for example, when about 1 to 2 liters of coolant is lost and mixed with air and the like), the coolant level sensor mounted either on the coolant loop or on the heating loop cannot detect the loss of the coolant but still recognizes the current level as a normal level.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a device and method for detecting the coolant level in a thermal management system for a fuel cell vehicle, which can accurately and rapidly monitor the lack of coolant by calculating in real time the lack of coolant based on a change in slope value and a change in amplitude of a detection value of a pressure sensor according to the flow of coolant in a state where the pressure sensor is mounted on a coolant line connected to an inlet of a fuel cell stack and a reservoir is connected to a pressure cap of a radiator.

In one aspect, the present invention provides a device for detecting the coolant level in a thermal management system for a fuel cell vehicle, characterized in that a reservoir for supplementing coolant is connected to an upper end of a radiator and a pressure sensor is mounted on a coolant circulation line connected to an inlet of a fuel cell stack so that, when the pressure sensor measures a flow pressure of coolant in real time and transmits the measured value to a controller, the controller determines whether the coolant is insufficient based on a change in slope value and a change in amplitude of the flow pressure of coolant transmitted from the pressure sensor. In some exemplary embodiments, the device may further comprise a pressure cap mounted on an upper end of the radiator connected to the reservoir.

In another aspect, the present invention provides a method for detecting the coolant level in a thermal management system for a fuel cell vehicle, the method including: measuring, at a pressure sensor, the flow pressure of coolant fed into a fuel cell stack; determining whether the coolant is insufficient based on a change in slope value and a change in amplitude in data of the flow pressure of coolant; lighting a warning light on a cluster to warn a driver, once the controller determines that the coolant is insufficient; and limiting the output of the fuel cell vehicle, when the controller determines that the coolant is still insufficient.

In an exemplary embodiment, when a change in sign of the slope value of the continuous data measured by the pressure sensor in real time is repeated for a predetermined number of times and, at the same time, a difference in pressure between the measurement data is above a threshold pressure, the first determination that the coolant is insufficient may be performed.

In another exemplary embodiment, when the first determination that the coolant is insufficient is repeated more than a threshold number of times, the limiting of the output of the fuel cell vehicle may be performed.

In still another exemplary embodiment, when the detection value of five continuous data measured by the pressure sensor in real time is the normal pressure for a lower RPM and, at the same time, when the RPM of a pump is greater than a predetermined value, the limiting of the output of the fuel cell vehicle may be performed.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing the configuration of a device for detecting the coolant level in a thermal management system for a fuel cell vehicle.

FIG. 2 is a graph showing the operation state of a fuel cell system when coolant is full in accordance with a Test Example of the present invention.

FIG. 3 is a graph illustrating the change in pump RPM and the change in slope value and amplitude of a detection value of a pressure sensor when coolant is insufficient in accordance with a Test Example of the present invention.

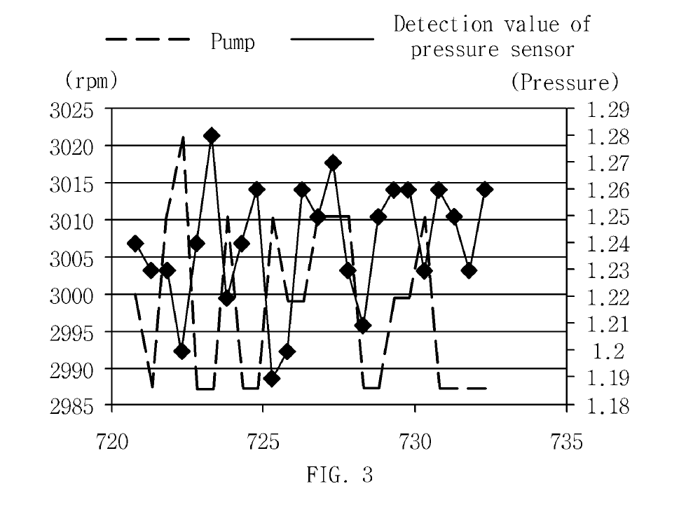

FIG. 4 is a diagram showing the configuration of a conventional device for detecting the coolant level in the thermal management system for a fuel cell vehicle.

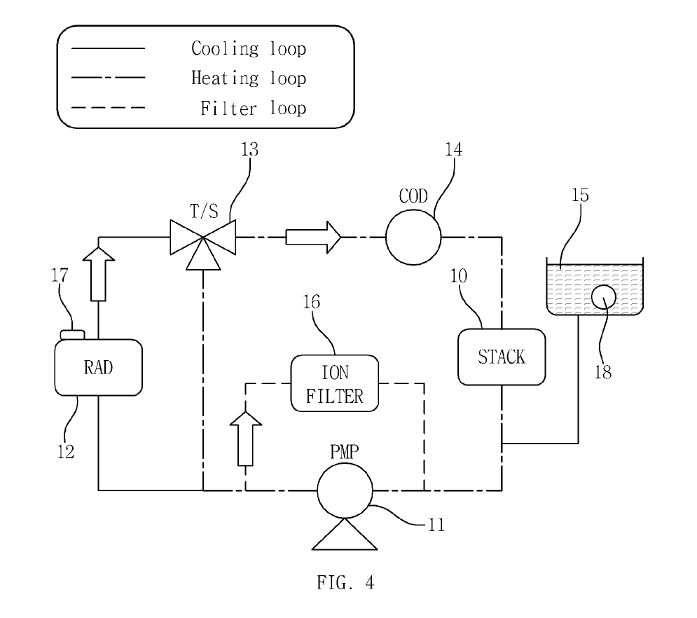

Reference numerals set forth in the Drawings includes reference to the following elements as further discussed below:

10: fuel cell stack

11: pump

12: radiator

13: three-way valve

14: COD

15: reservoir

16: ion filter

17: normal pressure cap

18: coolant level sensor

20: pressure sensor

22: pressure cap

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

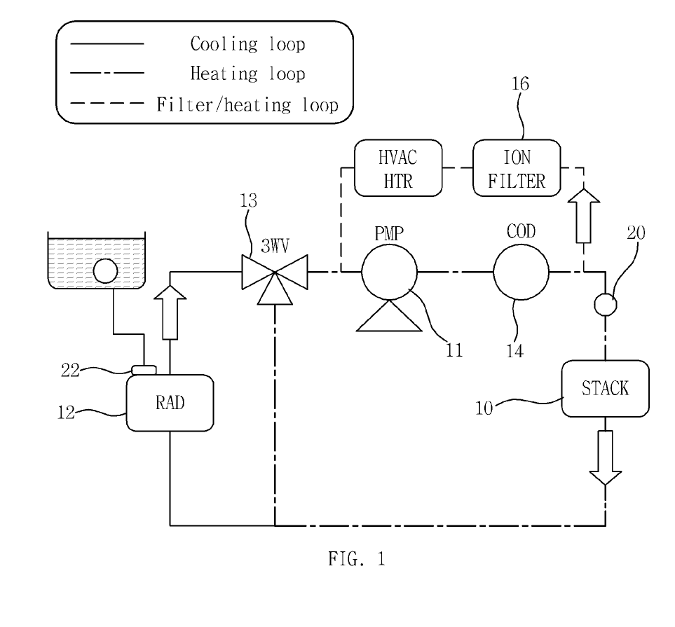

The present invention is aimed at accurately and rapidly detecting the lack of coolant based on a detection value of a pressure sensor, unlike a convention method of determining the lack of coolant using a coolant level sensor in a reservoir in the event of lack of coolant due to evaporation or leakage of the coolant flowing through a coolant circulation loop. To this end, as shown in FIG. 1, a pressure sensor 20 is mounted in the uppermost position of a cooling system in a thermal management system, i.e., in a position connected to an inlet of a fuel cell stack 10 in a coolant circulation loop.

The pressure sensor 20 is mounted in a position connected to the inlet of the fuel cell stack 10 in the coolant circulation loop to maximize the signal deviation (in the slope value and amplitude) of the pressure sensor due to the flow of coolant together with air bubbles when the amount of coolant is insufficient. Accordingly, when the pressure sensor 20 mounted in a position connected to the inlet of the fuel cell stack 10 measures the flow pressure of the coolant, the flow pressure can be easily measured when the coolant is full. On the contrary, when the coolant is insufficient, the change in slope value and amplitude of the detection value measured by the pressure sensor 20 frequently occurs, and thus logic for the lack of coolant is constructed using the same.

In more detail, when the coolant is mixed with air bubbles due to the lack of coolant, only the coolant is in contact with the pressure sensor 20 and only the air bubbles are in contact with the pressure sensor 20 due to the lack of coolant continuously. As a result, the change in sign of the slope value and the change in amplitude of the slope value frequently occur, and thus a method for determining the lack of coolant based on the change in slope value and the change in amplitude is achieved.

Next, the method for determining the lack of coolant according to the present invention will be described.

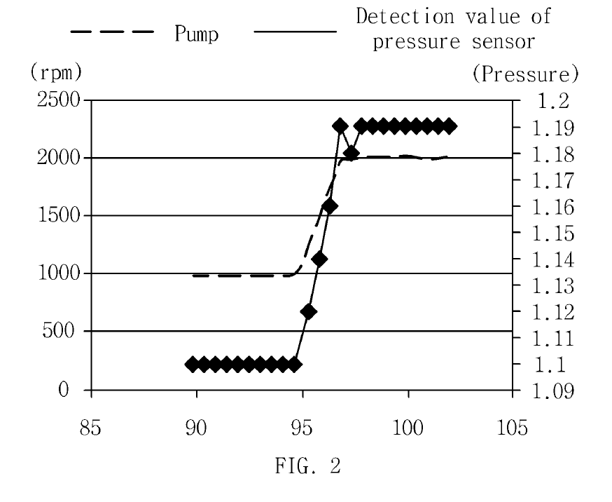

First, when the flow pressure of coolant is measured by the pressure sensor 20 mounted in a position connected to the inlet of the fuel cell stack 10, the flow pressure when the coolant is full is increased as the revolutions per minute (RPM) of the pump increases, thus determining that the coolant is sufficient, as shown in FIG. 2. On the contrary, when the coolant is insufficient due to evaporation or leakage of coolant, a change the flow pressure measured by the pressure sensor occurs as a result (i.e., fluctuation in the values observed by the pressure senor). That is, the sign of the slope value of the detection value measured by the pressure sensor frequently changes, and the amplitude of the slope value excessively changes as a result.

Accordingly, a controller receiving the measurement data of the pressure sensor determines the lack of coolant based on the change in sign of the slope value of the detection value and the change in amplitude through first and second steps. The first determination of the lack of coolant is performed based on the change in sign of the slope value of continuity data measured in real time and the difference in pressure between the measurement data.

In more detail, when the measured data from the pressure sensor received by the controller over an interval of 5 seconds is Xₙ to Xₙ₊₉, when “[the sign of Xₙ₊₁-Xₙ, changes more than 5 times] and [the abs(X₊₁-Xₙ) is greater than 0.03 bar more than 4 times]”, the controller first determines the lack of coolant and illuminates a warning light on a cluster to warn a driver.

In other words, when the change in sign of the slope value of the continuous data measured by the pressure sensor is repeated over a predetermined number of times (i.e., the sign of Xₙ₊₁-Xₙ changes more than 5 times) and, at the same time, the difference in pressure between the measurement data is above a threshold pressure (i.e., abs(X₊₁-Xₙ) is greater than 0.03 bar), the controller first determines the lack of coolant and illuminates the cluster warning light to warn the driver. Next, after the warning step, when the lack of coolant is again (i.e., a second time) detected, the output of the fuel cell vehicle is limited by the system.

In other exemplary embodiments, when the first determination of the lack of coolant is repeated more than a threshold number of times, the controller may perform logic for limiting the output of the fuel cell vehicle. For example, when the determination of the lack of coolant is repeated more than 6 times to illuminate the warning light a total of 10 times based on the first determination, the controller may perform the logic for limiting the output of the fuel cell vehicle.

In another exemplary embodiment, when the detection value of continuous data of more than 5 times measured by the pressure sensor in real time is the normal pressure for a lower or idling RPM and, at the same time, when the RPMs of the pump is greater than a predetermined value, the controller may perform the logic for limiting the output of the fuel cell vehicle, as well. That is, for example, when the measurement data received by the controller is Xₙ to Xₙ₊₉, when “[the avg(Xₙ₊₅ to Xₙ₊₉) is equal to 0 and the RPMs of the pump is greater than 1,600]”, the controller may perform the logic for limiting the output of the fuel cell vehicle.

In more detail, when the detection value of five continuous data collections (Xₙ₊₅ to Xₙ₊₉) selected from the continuous data (Xₙ to Xₙ₊₉) measured by the pressure sensor in real time is equal to 1 and, at the same time, when the RPMs of the pump are greater than 1,600 RPMs, the controller again (i.e., a second time) determines that the coolant is still insufficient and perform the logic for limiting the output of the fuel cell vehicle (i.e., a second determination). Here, the fact that the slope value of the continuous data (Xₙ to Xₙ₊₉) is 1 means the normal pressure (e.g., for a lower RPM) of the flow pressure of the coolant cannot be detected due to the lack of coolant in the system.

As described above, the present invention provides the following effects.

With the use of the pressure sensor mounted in the uppermost position of the thermal management system, not in the reservoir of the thermal management system, it is possible to accurately and rapidly monitor whether the coolant in insufficient based on the change in slope value and the change in amplitude of the flow pressure of the coolant measured by the pressure sensor.

Moreover, due to the configuration in which the reservoir is connected to the top of the radiator and the pressure cap is mounted in a filler neck connected to the reservoir, it is possible to minimize the flow noise of coolant, and the amount of coolant evaporated. Furthermore, the coolant level sensor in the reservoir can be eliminated, and thus the packaging is more efficient and the manufacturing costs are reduced.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1-2. (canceled)

3. A method for detecting the coolant level in a thermal management system for a fuel cell vehicle, the method comprising:
measuring, by a pressure sensor, the flow pressure of coolant fed into a fuel cell stack;
determining, by a controller, whether the coolant is insufficient based on a change in slope value and a change in amplitude in data of the flow pressure of coolant;
illuminating a warning light on a cluster of a vehicle to warn a driver, when the coolant is first determined to be insufficient; and
limiting the output of the fuel cell vehicle, when it is again determined that the coolant is still insufficient.

4. The method of claim 3, wherein, when a change in sign of the slope value of the continuous data measured by the pressure sensor in real time is repeated for a predetermined number of times and, at the same time, a difference in pressure between the measurement data is above a threshold pressure, is the coolant is determined to be insufficient and is marked as a first determination.

5. The method of claim 3, wherein, when the first determination that the coolant is insufficient is repeated more than a threshold number of times, the output of the fuel cell vehicle is limited in response.

6. The method of claim 3, wherein, when the detection value of five continuous data measured by the pressure sensor in real time is a normal pressure for a lower RPM while the RPMs of a pump are greater than a predetermined value, the output of the fuel cell vehicle is limited in response.
